(19) United States
(12) Patent Application Publication
(10) Pub. No.: US 2014/0369777 A1
(43) Pub. Date: Dec. 18, 2014

(54) METHOD FOR PRODUCING A TOOTHING

(71) Applicant: Loesomat Schraubtechnik Neef GmbH, Vaihingen/Enz (DE)

(72) Inventors: Marc Gareis, Leonberg (DE); Klaus Wilczek, Ehningen (DE)

(73) Assignee: LOESOMAT SCHRAUBTECHNIK NEEF GMBH, Vaihingen/Enz (DE)

(21) Appl. No.: 14/367,424

(22) PCT Filed: Dec. 12, 2012
(86) PCT No.: PCT/DE2012/001186

§ 371 Date: Jun. 20, 2014

(30) Foreign Application Priority Data
Dec. 21, 2011 (DE) 10 2011 121 784.7

(51) Int. Cl. B23F 5/16; B23F 5/12

(52) U.S. Cl. CPC B23F 5/16; B23F 5/12
USPC 409/12

(57) ABSTRACT

A method for producing a toothing on an in particular round workpiece, wherein the teeth are produced by a shaping method using a tool which moves along a path which is controlled by a lifting cam and in the case of which an exchange movement that runs substantially in the radial direction of the workpiece follows a downward movement which runs in the axial direction of the workpiece and serves to produce the tooth flanks, wherein the exchange movement is superimposed with a downward movement such that a curved path is produced during the exchange, is characterized in that the relative rake angle γᵣₑₗ of the tool (200) does not fall below a minimum rake angle γₘᵢₙ which corresponds to the rake angle γ of the tool (200), the rake angle γ being reduced by the angle δ between the longitudinal axis of the workpiece and the direction vector of the tool movement.

The invention relates to a method for producing a toothing on a workpiece that is especially round, wherein the teeth are produced by an impact hobbing method with a tool which moves along a path which is controlled by a lifting cam, in which a downward movement used for producing the tooth flank and extending in the axial direction of the workpiece is followed by an exit movement that runs substantially in the radial direction of the workpiece and obliquely to the downward movement.

### DESCRIPTION OF THE PRIOR ART

Gear hobbing and impact hobbing methods are known from the state of the art for producing gearwheels. External and internal toothings can be produced by means of impact hobbing methods in cylindrical bodies for example. Successive impact hobbing processes are also performed in the case of long axial tooth flanks. This is generally known in the state of the art as “shuttle impacts”. In the impact hobbing method, the tool passes through an orbit in which a downward movement of the tool extending in the axial direction of the workpiece is followed by an exit movement extending obliquely to the downward movement and substantially in the radial direction of the workpiece, which exit movement coasts out of the workpiece to be processed in an arc-like fashion after the downward movement. During the last stroke, the contour of the workpiece is chosen in such a way that the tool (impact tool) coasts axially out of the contour of the workpiece to be produced. For this reason, constructional notches are provided at the end of the tooth flanks, i.e. grooves which extend at least with such a depth into the workpiece that they end at least at the tooth gullet. Such constructional notches represent a weakening of the workpiece, which should be avoided especially under high loads, to which such toothings are subjected especially in power wrenches.

It is further known from JP 01-115513 A for example to produce a toothing on a round workpiece, in that the teeth are produced by an impact hobbing method by a tool which travels an orbit controlled by a lifting cam, in which a downward movement used for producing the tooth flank and extending in the axial direction of the workpiece is followed by an exit movement extending substantially in the radial direction of the workpiece, wherein the exit movement is superimposed by a downward movement in such a way that a curved orbit is produced during the exit. Although constructional notches are not produced in this process, but a curved transition at the end of the tooth flanks, it is likely however that the tool will wear off very rapidly by this method.

The invention is therefore based on the object of providing a method for producing a toothing in an especially round workpiece, which prevents constructional notches during the production of the toothing and which can be performed without any relevant wear and tear of the tool.

### DISCLOSURE OF THE INVENTION

### Advantages of the invention

This object is achieved by a method for producing a toothing of the kind mentioned above in such a way that the exit movement is superimposed by a downward movement in such a way that a curved orbit is obtained during the exit. The relative rake angle γᵣₑₗ of the tool does not fall beneath a minimum rake angle γₘᵢₙ at any point in time of the exit movement, which minimum rake angle corresponds to the rake angle γ of the tool, said rake angle being reduced by the angle δ between the longitudinal axis of the workpiece and the direction vector of the tool movement. The relative rake angle δᵣₑₗ is understood in accordance with the invention as being the angle between the surface of the tool and a straight line which stands perpendicularly to the direction vector of the exit movement of the tool. The angle δ can be determined for example as an arc tangent of the time derivative of the radial component of the direction vector of the tool movement which is divided by the time derivative of the axial component.

An undercut in the run-out of the tooth flanks can advantageously be avoided by this measure. A curved transition at the end of the tooth flanks is achieved instead by superimposing the downward movement and the exit movement and the choice of the radius, which curved transition—in contrast to an undercut arrangement there—enables an enlargement in the material and thus an increase in the stability. This is possible without any major wear and tear of the tool, as compared to production of the toothing by using an undercut.

Advantageous further developments and improvements of the method mentioned in the independent claim are enabled by the measures mentioned in the dependent claims.

The radius with which the tool is moved during the exit movement can principally be selected and set. A highly advantageous embodiment of the method provides that the transition from the downward movement to the exit movement occurs continuously and steadily with a very small radius.

Preferably, the angle between the downward movement direction and the exit movement direction at the end of the tooth flank is slightly more than 90°. The tool is thus not moved in the radial direction at the end of the tooth flank, but the radial direction is superimposed with an axial direction, i.e. the tool is moved downwardly or upwardly in an oblique manner, as seen in the axial direction of the tool. This leads to a continuously curved run-out of the tooth flanks and thus to the desired increase in the stability in the region of the end of the tooth flanks and thus at the end of the toothing.

The use of a tool arranged as a bell wheel has proven to be especially advantageous for producing internal toothings in particular. With such a bell wheel, internal toothings can be produced in a simple, rapid and precise way by means of the aforementioned shuttle impacts.

An external toothing can respectively also be produced by means of such a bell wheel, wherein in this case a simultaneous rotation of the workpiece is necessary during the machining process.

The workpiece can have a diameter which changes at one point of the workpiece by at least half the diameter of the tool. Typical tool diameters lie in the range of 20 mm to 25 mm. It is not possible with conventional gear hobbing or impact hobbing methods to produce an external toothing on workpieces with such a large change in diameter, which external toothing ends in the region of the change in diameter because in this case secure exiting of the tool is no longer possible.

The workpiece itself preferably has a cylindrical profile or a hollow-cylindrical profile.

If the workpiece is arranged as a hollow cylinder in which an internal toothing is to be produced, the method in accordance with the invention allows that their teeth have a tooth height which at least corresponds to the diameter of the hollow space or cup in the hollow cylinder.

The workpiece preferably consists of a high-strength high-performance aluminium alloy.

Such aluminium alloys can be machined especially well by means of the aforementioned impact hobbing. It is also possible to machine workpieces that consist of steel.

### BRIEF DESCRIPTION OF THE DRAWINGS

Embodiments of the invention are shown in the drawings and are explained in the description below in closer detail. Features can be relevant either separately or in combination with each other, wherein:

FIG. 1 schematically shows a sectional view of a workpiece in which the toothings were produced by production methods known from the state of the art;

FIG. 2 shows a sectional enlargement of the region designated with reference numeral II in FIG. 1;

FIG. 3 shows a workpiece which is comparable to FIG. 1, in which the internal and external toothing was produced by means of the method in accordance with the invention;

FIG. 4 shows a sectional enlargement designated in FIG. 3 with reference numeral IV;

FIG. 5 shows a schematic view of the method in accordance with the invention prior to the start of the lift-off movement of the tool;

FIG. 6 shows a schematic view of the method in accordance with the invention during the lift-off movement of the tool;

FIG. 7 shows a schematic view of the method in accordance with the invention at the end of the lift-off movement of the tool, and

FIG. 8 shows a view of the tool stroke over the lift-off movement of the tool cam in an embodiment of the method in accordance with the invention.

### DESCRIPTION OF THE PREFERRED EMBODIMENTS

A workpiece designated in its entirety with reference numeral 100 is arranged as a hollow cylinder for example. The hollow cylinder 105 has an internal toothing 110 at one of its ends. An external toothing 150 is provided at its other end. Both the external toothing as well as the internal toothing are characterized in that an undercut 115 is provided at the one end in the case of the internal toothing 110 and an undercut 155 in the case of the external toothing 150. This occurs because both the internal toothing 110 and also the external toothing 150 are produced by an impact hobbing process in the known manner by means of a tool which travels an orbit controlled by a lifting cam, in which a downward movement of the tool which is used in tooth flank production and extends in the axial direction of the workpiece is followed by an exit movement which extends obliquely to the downward movement and substantially in the radial direction of the workpiece. The tool therefore runs linearly over a prolonged period of time in the axial direction and then converges into a curved arc-like movement in order exit from the workpiece again. Such impact hobbing processes are performed successively in the case of long toothings. This successive sequence of shuttle-like downward impact processes is known as “shuttle impacts”. In this process, the type of the superposition of the downward movement, i.e. the movement of the tool in the axial direction of the workpiece, and the exit movement, i.e. the movement of the tool obliquely to the downward movement, is irrelevant because undesirable excess portions of material formed by a second impact hobbing process following the first impact hobbing process as a result of the arc-like movement of the tool in the machined workpiece are eliminated by a downward movement following at this point. For this reason, the respective undercuts 115 and 155 are also provided at the end of the tooth, which undercut must be so deep and must be arranged with such a length in the axial direction that the arc-like movement of the tool, i.e. a bell wheel for example, is taken into account to such an extent that a “contactless” exit movement is possible at the end of the tooth flank.

Such an undercut 115, which must extend at least in the radial direction to such an extent into the workpiece that it is at least as deep as the tooth gullet and which in the axial direction of the workpiece must be arranged with such a length that a downward movement of the tool is still present at the end of the tooth flank, weakens the workpiece at the end of the toothing.

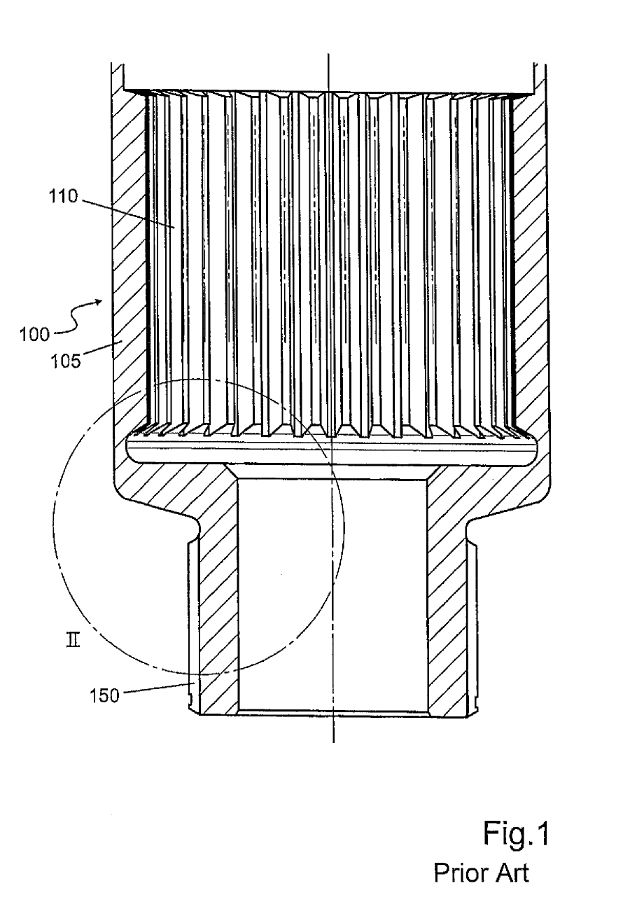

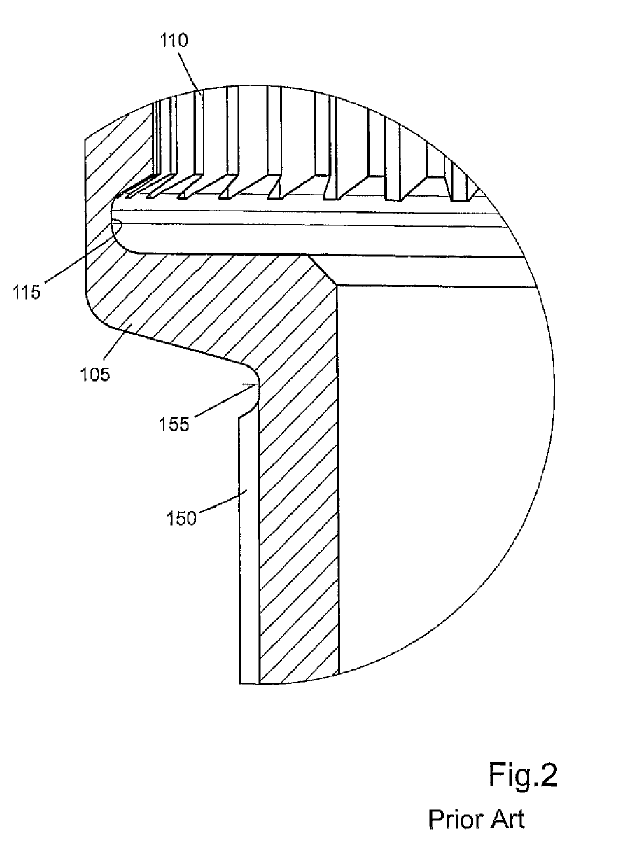

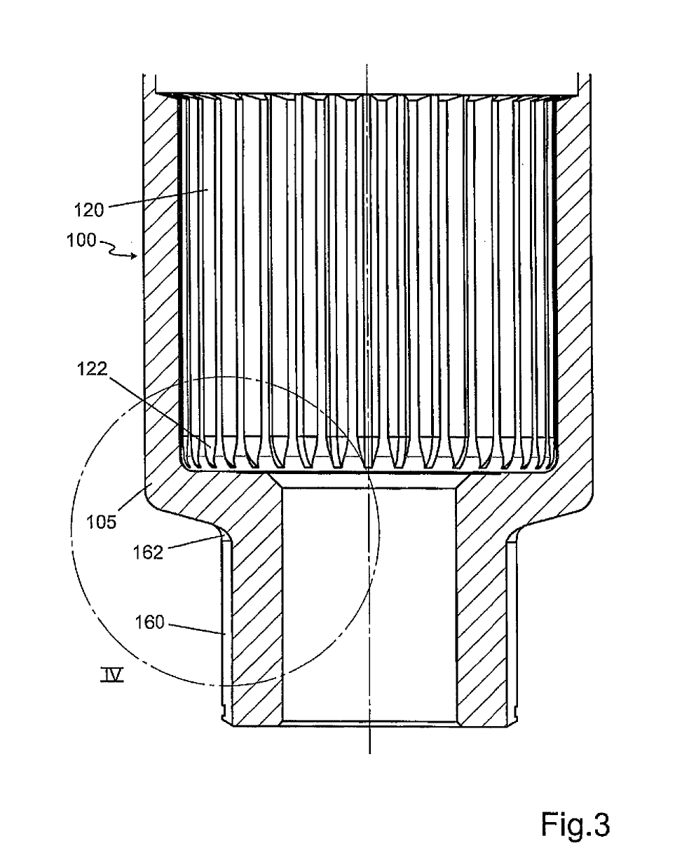

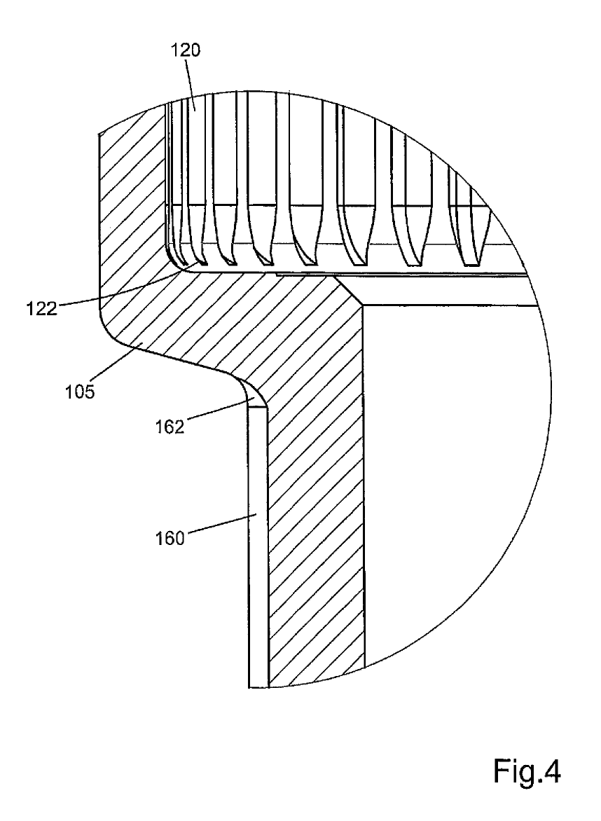

It is the principal idea of the invention to further develop such an impact hobbing method and especially so-called shuttle impacts in such a way that an undercut can be avoided completely. The method will be explained below by reference to FIGS. 3 and 4, wherein the same elements are provided with the same reference numerals as in FIG. 1 and FIG. 2. A hollow-cylindrical workpiece 100 is again provided which has different diameters, wherein an internal toothing 120 is provided in a region, the tooth flanks of which correspond to the internal toothing 110, and an external toothing 160 is provided in another region, the tooth flanks of which correspond to those of the external toothing 150.

No undercut is provided in contrast to the toothings shown in FIGS. 1 and 2. Instead, the toothings taper off in a curved fashion at their respective ends in the regions 122 and 162. This curved tapering off is produced in such a way that the exit movement of the tool is superimposed by a downward movement in such a way that a curved orbit is obtained during the exit. This curved orbit is shown especially clearly in the sectional enlargement of FIG. 4. It is provided with the reference numeral 122 in the internal toothing and with the reference numeral 162 in the external toothing. The transition from the downward movement in the axial direction of the workpiece 100 to the exit movement, i.e. substantially obliquely to the axial direction and virtually in the radial direction of the workpiece 100, occurs in a substantially continuous and steady fashion with a very small radius. It is provided that in the region of the tooth flanks the angle between the downward movement and the exit movement is slightly larger than 90°, i.e. the exit movement does not occur in the radial direction in the region of the tooth flanks, but obliquely to the radial direction, but at a very small angle. An oblique progression is obtained in this manner in the regions of the ends of the tooth flanks 122, 162, which at this point—in contrast to the state of the art—does not lead to any thinning of the material. Instead, it even enables a thickening of the material and thus leads to an increase in the stability in combination with simple production at the same time.

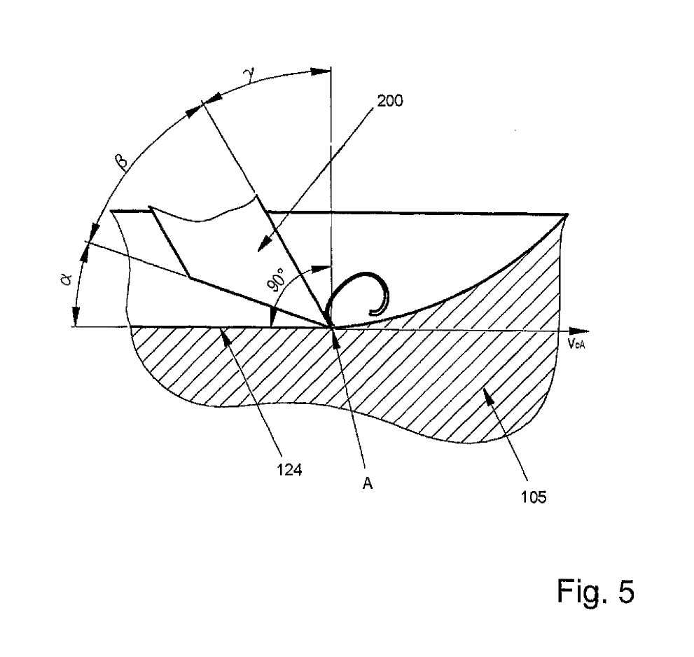

FIG. 5 shows how a tooth flank 122 can be produced by means of the method in accordance with the invention. A tool 200 acts in a clearance angle a towards the tooth gullet 124 on the surface or in a surface of the hollow cylinder 105. The clearance angle a thus describes an angle of the clearance between the tool 200 and the surface to be machined. This tool 200 is shaped in the manner of a wedge and its blade has a wedge angle β. The angle between the surface of the tool 200 and a straight line which stands perpendicularly to the tooth gullet 124 is known as the rake angle γ. It influences the compression and running off of a chip and the heat distribution during machining. Said rake angle γ is chosen depending on the hardness of the hollow cylinder material. The sum total of the clearance angle a and the wedge angle β is known as cutting angle. The sum total of the clearance angle a, the wedge angle β and the rake angle γ is 90° . The tool 200 cuts with a first cutting velocity v_{cA} parallel to the longitudinal axis of ₜhe hollow cylinder 105 up to a point A, up to which the tooth flank 122 is to extend parallel to the longitudinal axis of the hollow cylinder 105. The relative rake angle γᵣₑₗ corresponds in this case to the rake angle γ.

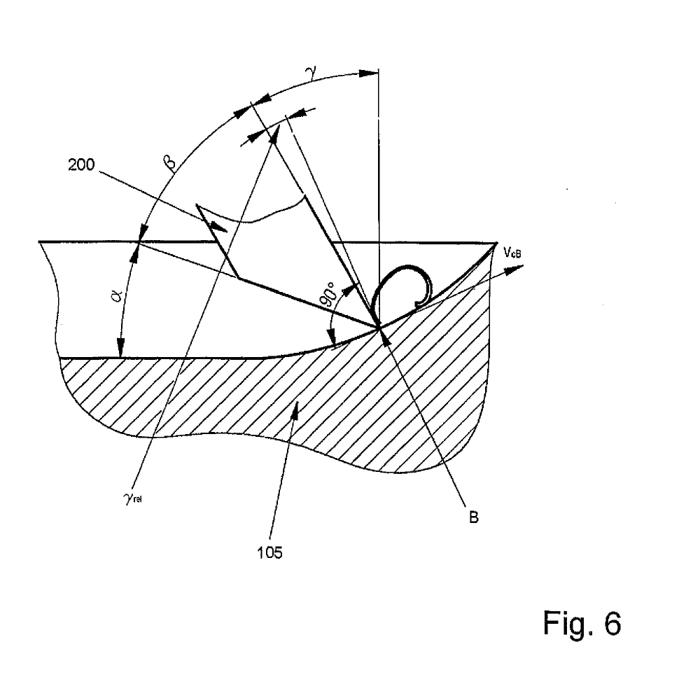

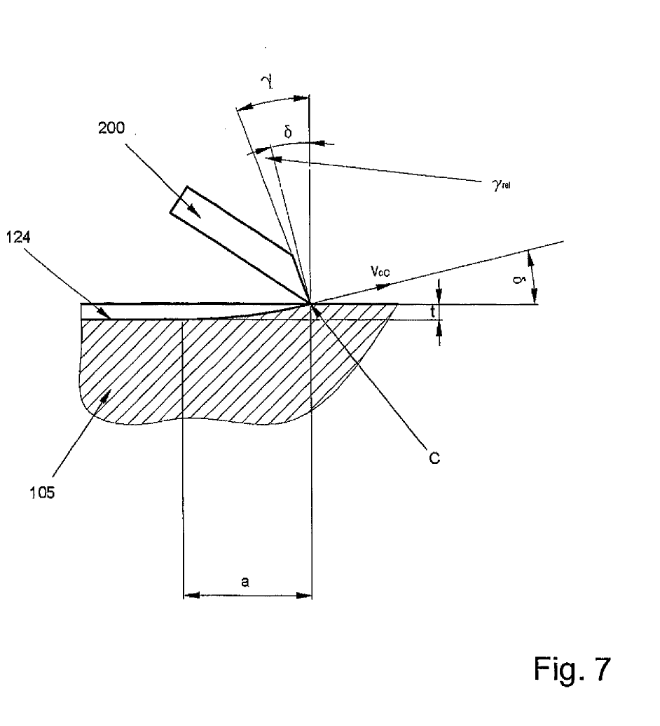

Following the exit movement, the direction vector of the cutting movement deviates from the longitudinal axis of the hollow cylinder 105. It occurs for example at a point B with a second cutting velocity v_{cB}, which is shown in FIG. 6. FIG. 7 shows the tool at a point C at the end of the exit movement. The distance between the points A and C, i.e. between the start and the end of the exit movement, is known as the run-out a. The distance between the points A and C in the radial direction, which is caused by the stroke of the tool 200, is designated with reference t in FIG. 7. The tool 200 has a third cutting velocity v_{cC} at point C.

The relative rake angle γᵣₑₗ corresponds to the angle between the surface of the tool 200 and the straight line which stands perpendicularly to the direction vector of the exit movement of the tool. It is shown in FIGS. 6 and 7 for the points B and C.

The permissible minimum value γₘᵢₙ of the relative rake angle γᵣₑₗ is calculated according to formula 1 in each point of the exit movement as the difference between the rake angle γ and the angle δ between the direction vector of the movement of the tool 200 and the longitudinal axis of the hollow cylinder 105:

γᵣₑₗ≧γₘᵢₙ=γ−δ (Formula 1)

If the value falls beneath this minimum value γₘᵢₙ, there is an increased risk that the tool 200 will break.

In FIG. 7, the relative rake angle γᵣₑₗ precisely corresponds to its permissible minimum value γₘᵢₙ at point C.

The angle δ can be determined according to formula 2 as an arc tangent of the time derivative of the radial component \dot{x} of the direction vector of the tool movement which is divided by the time derivative of the axial component \dot{y}:

$$δ = arctan ( \frac{\dot{x}}{\dot{y}} ) \qquad ( Formula 2 )$$

The direction vector shall be understood as being the vector in each point of the exit movement which can be placed as a tangent on the tooth gullet, i.e. in the points B and C the vector of the velocity v_{cB} and v_{cC}. Prior to the start of the exit movement, the direction vector extends parallel to the longitudinal axis of the hollow cylinder 105 and thus corresponds to the vector of the velocity v_{cC}.

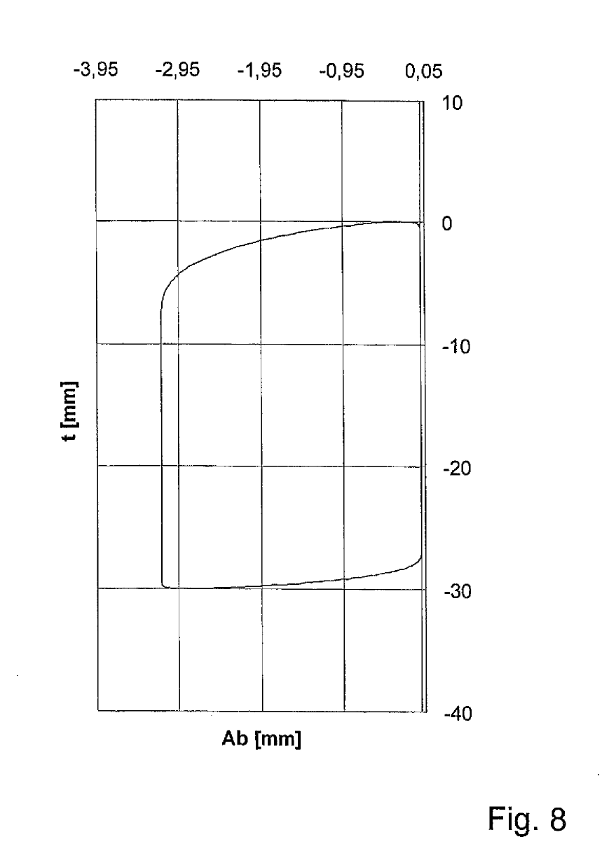

The movement of the tool 200 is controlled by a lifting cam. FIG. 8 shows the stroke t of the tool 200 depending on the lift-off Ab of the lifting cam in one embodiment of the method in accordance with the invention.

The production of the tooth flanks, and the internal toothing in particular, can be performed by means of a bell wheel, as already explained above. Long toothings can be produced by means of shuttle impacts that were also already explained above.

Aluminium and aluminium alloys have proven to be especially advantageous for the application of the method in accordance with the invention. It can principally also be used with steels. A typical rake angle γ for aluminium is 25°, whereas a conventional rake angle γ for steel is 10°.

1-8. (canceled)

9. A method for producing a toothing on a workpiece (100) that is especially round, wherein the teeth (120) are produced by an impact bobbing method with a tool (200) which moves along a path which is controlled by a lifting cam, in which a downward movement used for producing the tooth flank and extending in the axial direction of the workpiece (100) is followed by an exit movement that runs substantially in the radial direction of the workpiece (100), wherein the exit movement is superimposed by a downward movement such that a curved orbit is obtained during the exit, wherein the relative rake angle γᵣₑₗ of the tool (200) does not fall beneath a minimum rake angle γₘᵢₙ, which minimum rake angle corresponds to the rake angle γ of the tool (200), said rake angle being reduced by the angle δ between the longitudinal axis of the workpiece (100) and the direction vector of the tool movement.

10. A method according to claim 9, wherein the angle δ is determined as an arc tangent of the time derivative (\dot{x}) of the radial component of the direction vector of the tool movement which is divided by the time derivative (\dot{y}) of the axial component.

11. A method according to claim 9, wherein the tool (200) is a bell wheel.

12. A method according to claim 11, wherein the workpiece (100) has a diameter which at one point of the workpiece (100) changes by at least half the diameter of the tool (200).

13. A method according to claim 9, wherein the workpiece (100) has a cylindrical profile or is formed by a hollow cylinder.

14. A method according to claim 13, wherein the workpiece (100) is arranged as a hollow cylinder in which an internal toothing (120) is produced, whose teeth (120) have a tooth height which corresponds at least to the diameter of the hollow space in the hollow cylinder.
